(19) United States
(12) Patent Application Publication
(10) Pub. No.: US 2022/0315230 A1
(43) Pub. Date: Oct. 6, 2022

(54) SEAT PAN ADJUSTMENT AND CONTROL SYSTEMS AND METHODS FOR CONTROLLING SEAT PAN ADJUSTMENT

(71) Applicant: AMI INDUSTRIES, INC., Colorado Springs, CO (US)

(72) Inventors: Jackson Fulcher, Colorado Springs, CO (US); Steve Holstine, Colorado Springs, CO (US)

(73) Assignee: AMI INDUSTRIES, INC., Colorado Springs, CO (US)

(21) Appl. No.: 17/224,015

(22) Filed: Apr. 6, 2021

(51) Int. Cl. B64D 25/10; B64D 11/06

(52) U.S. Cl. CPC B64D 25/10; B64D 11/0647; B64D 11/0616; B64D 11/064; B64D 11/0648

(57) ABSTRACT

An ejection seat may comprise a seat back a seat pan configured to translate along the seat back, and a seat pan adjustment system configured to adjust a positioning of the seat pan. The seat pan adjustment system may comprise a first actuator configured to adjust a position of a first area of the seat pan, a second actuator configured to adjust a position of a second area of the seat pan, and a controller configured to send in-flight actuation commands to the first actuator and the second actuator.

### FIELD

The present disclosure relates to ejection seats and, more specifically, to seat pan adjustment and control systems and methods for controlling seat pan adjustment.

### BACKGROUND

Certain aircraft may include ejection systems designed to eject a member of the flight crew from the aircraft in certain situations. These ejection systems typically include an ejection seat in which the member of the flight crew is located during flight. During a long flight, the ejection seat occupant may experience discomfort due to, for example, the occupant's legs “falling asleep”, lack of movement, prolonged pressure in a particular area of the body (e.g., the coccyx), and/or lack of blood flow to the legs. This discomfort can limit the occupant's ability to maneuver the aircraft and/or may lead to shorter flight times.

### SUMMARY

An ejection seat is disclosed herein. In accordance with various embodiments, the ejection seat may comprise a seat back, a seat pan configured to translate along the seat back, and a seat pan adjustment system configured to adjust a positioning of the seat pan. The seat pan adjustment system may comprise a first actuator configured to adjust a position of a first area of the seat pan, a second actuator configured to adjust a position of a second area of the seat pan, and a controller configured to send in-flight actuation commands to the first actuator and the second actuator.

In various embodiments, a first side panel may be located along a first side of the seat pan. A second side panel may be located along a second side of the seat pan opposite the first side of the seat pan. A first guide pin may be coupled to the first side of the seat pan and located in a first pin channel defined by an inboard surface of the first side panel. A second guide pin may be coupled to the second side of the seat pan and located in a second pin channel defined by an inboard surface of the second side panel.

In various embodiments, the first actuator may be located proximate the first side of the seat pan, and the second actuator may be located proximate the second side of the seat pan. In various embodiments, the seat pan adjustment system may further comprise a primary actuator operably coupled to the seat pan. Actuation of the primary actuator may cause the seat pan, the first actuator, and the second actuator to translate relative to the seat back.

In various embodiments, the primary actuator may be located under the seat pan. In various embodiments, the primary actuator may be configured to remain stationary and the first actuator and the second actuator may translate with the seat pan during expulsion of the ejection seat. In various embodiments, the controller may be configured to send an initial actuation command to at least the primary actuator to position the seat pan at an occupant-specific starting position. The controller may send the in-flight actuation commands to at least one of the first actuator or the second actuator at a pre-selected time interval after sending the initial actuation command to the primary actuator.

In various embodiments, the seat pan adjustment system may further comprise a third actuator configured to adjust a position of a third area of the seat pan, and a fourth actuator configured to adjust a position of a fourth area of the seat pan. The first actuator may be located proximate a left-front of the seat pan, the second actuator may be located proximate a right-front of the seat pan, the third actuator may be located proximate a left-back of the seat pan, and the fourth actuator may be located proximate a right-back of the seat pan.

A seat pan adjustment system for an ejection seat is also disclosed herein. In accordance with various embodiments, the seat pan adjustment system may comprise a first actuator configured to adjust a position of a first area of a seat pan, a second actuator configured to adjust a position of a second area of the seat pan, a controller in communication with the first actuator and the second actuator, and a tangible, non-transitory computer-readable storage medium having instructions stored thereon for adjusting the seat pan. In response to execution by the controller, the instructions may cause the controller to perform operations. The operation may comprise sending, by the controller, an initial actuation command configured to position the seat pan at an occupant-specific starting position; and sending, by the controller, a series of in-flight actuation commands to the first actuator and the second actuator.

In various embodiments, the operations may further comprise receiving, by the controller, an occupant input; and determining, by the controller, the occupant-specific starting position based on the occupant input.

In various embodiments, sending, by the controller, the series of in-flight actuation commands to the first actuator and the second actuator may comprise sending, by the controller, a first in-flight actuation command to the first actuator at a first pre-set time after takeoff; and sending, by the controller, a second in-flight actuation command to the second actuator at a second pre-set time after takeoff. The first in-flight actuation command may be configured to adjust the position of the first area of the seat pan. The second in-flight actuation command may be configured to adjust the position of the second area of the seat pan.

In various embodiments, the operations may further comprise receiving, by the controller, a next position signal; and sending, by the controller, a next in-flight actuation command in the series of in-flight actuation commands in response to receiving the next position signal.

In various embodiments, the operations may further comprise receiving, by the controller, a return to start position signal; and sending, by the controller, an in-flight actuation command configured to position the seat pan at the occupant-specific starting position.

In various embodiments, the operations may further comprise receiving, by the controller, a stop adjustments signal. The controller may be configured to cease from sending any remaining in-flight actuation commands in the series of in-flight actuation commands in response to receiving the stop adjustment signal.

In various embodiments, a primary actuator may be configured to adjust a height of the seat pan. The controller may be configured to send the initial actuation command to at least the primary actuator. Actuation of the primary actuator may cause the seat pan, the first actuator, and the second actuator to translate relative to a seat back of the ejection seat.

A method for adjusting a seat pan of an ejection seat is also disclosed herein. In accordance with various embodiments the method may comprise the steps of receiving, by a controller, an occupant input; determining, by the controller, an occupant-specific starting position based on the occupant input; sending, by the controller, an initial actuation command configured to translate the seat pan from a neutral starting position to the occupant-specific starting position; and sending, by the controller, a series of in-flight actuation commands to a first actuator and a second actuator. The first actuator may be configured to adjust a position of a first area of the seat pan, and the second actuator may be configured to adjust a position of a second area of the seat pan.

In various embodiments, sending, by the controller, the series of in-flight actuation commands to the first actuator and the second actuator comprises the steps of sending, by the controller, a first in-flight actuation command to the first actuator at a first pre-set time after takeoff; and sending, by the controller, a second in-flight actuation command to the second actuator at a second pre-set time after takeoff.

In various embodiments, the method may further comprise the steps of receiving, by the controller, a return to start position signal; and sending, by the controller, an in-flight actuation command configured to position the seat pan at the occupant-specific starting position.

In various embodiments, the controller may send the initial actuation command to at least a primary actuator. Actuation of the primary actuator may cause the seat pan, the first actuator, and the second actuator to translate relative to a seat back of the ejection seat. In various embodiments, the method may further comprise the step of sending, by the controller, a final actuation command configured to position the seat pan at the neutral starting position.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the following illustrative figures. In the following figures, like reference numbers refer to similar elements and steps throughout the figures.

FIG. 1 illustrates an ejection seat being launched from an aircraft cockpit, in accordance with various embodiments;

FIG. 2 illustrates an ejection seat, in accordance with various embodiments;

FIGS. 3A and 3B illustrate a seat pan adjustment system, in accordance with various embodiments;

FIGS. 4A and 4B illustrate a left side panel and a right side panel, respectively of an ejection seat, in accordance with various embodiments;

FIGS. 5A and 5B illustrates a method for adjusting a seat pan of an ejection seat, in accordance with various embodiments; and

FIGS. 6A and 6B illustrate a seat pan adjustment system having a primary actuator and plurality of secondary actuators, in accordance with various embodiments.

### DETAILED DESCRIPTION

The detailed description of exemplary embodiments herein makes reference to the accompanying drawings, which show exemplary embodiments by way of illustration. While these exemplary embodiments are described in sufficient detail to enable those skilled in the art to practice the disclosures, it should be understood that other embodiments may be realized and that logical changes and adaptations in design and construction may be made in accordance with this disclosure and the teachings herein. Thus, the detailed description herein is presented for purposes of illustration only and not of limitation.

The scope of the disclosure is defined by the appended claims and their legal equivalents rather than by merely the examples described. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to tacked, attached, fixed, coupled, connected or the like may include permanent, removable, temporary, partial, full and/or any other possible attachment option. Additionally, any reference to without contact (or similar phrases) may also include reduced contact or minimal contact. Surface shading lines may be used throughout the figures to denote different parts but not necessarily to denote the same or different materials.

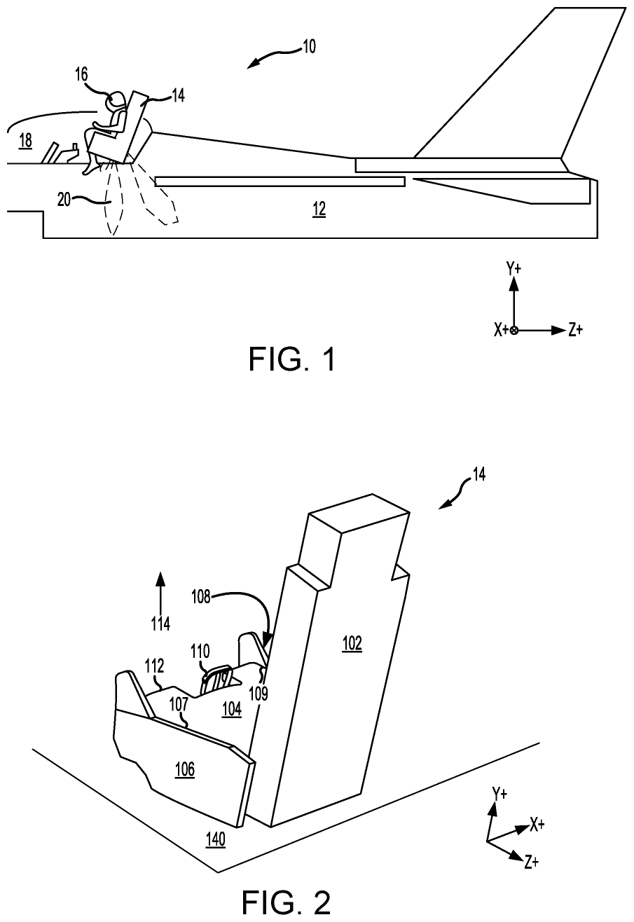

With reference to FIG. 1, an aircraft ejection system 10 is shown. In accordance with various embodiments, aircraft ejection system 10 may be installed in an aircraft 12 to expel an ejection seat 14 and an occupant 16 of ejection seat 14 from a cockpit 18 of aircraft 12. Ejection seat 14 may be urged from cockpit 18 by a propulsion system 20.

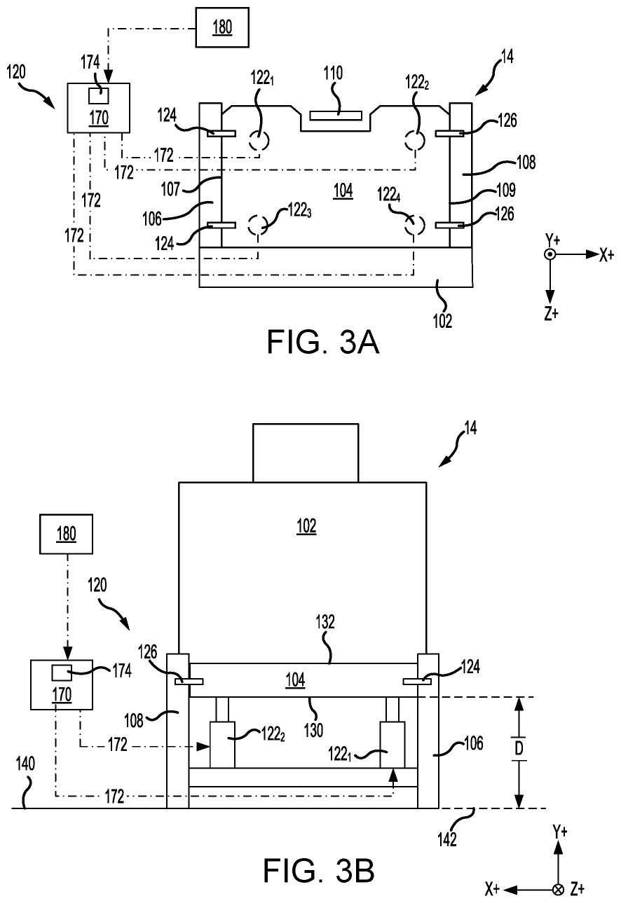

With reference to FIG. 2, and continuing reference to FIG. 1, ejection seat 14 of ejection system 10 is illustrated. Ejection seat 14 includes a seat back 102 and a seat pan 104. Seat pan 104 supports a bulk of the weight of the occupant 16. Seat pan 104 may have any shape on which a user may sit such as a flat shape, a curved shape, or the like. Ejection seat 14 includes a first (or left) side panel 106 and a second (or right) side panel 108. First side panel is located along a first (or left) side 107 of seat pan 104. Second side panel 108 is located along a second (or right) side 109 of seat pan 104. In this regard, second side panel 108 is located on an opposite side of seat pan 104 relative to first side panel 106. As described in further detail below, seat pan 104 may translate relative to seat back 102 and relative to first and second side panels 106, 108.

In various embodiments, an ejection handle 110 may be located proximate a frontside 112 of seat pan 104. Frontside 112 of seat pan 104 is generally opposite, or distal, seat back 102. While FIG. 2 shows ejection handle 110 located at frontside 112 of seat pan 104, it is further contemplated and understood that ejection handle 110 may be located anywhere that is accessible to an occupant of ejection seat 14. For example, ejection handle 110 may be located on first side panel 106 or in other locations in cockpit 18. Ejection handle 110 may be configured to initiate an ejection sequence upon actuation. For example, occupant 16 (FIG. 1) pulling ejection handle 110 in the direction of arrow 114 may initiate the ejection sequence that expels ejection seat 14 from aircraft 12.

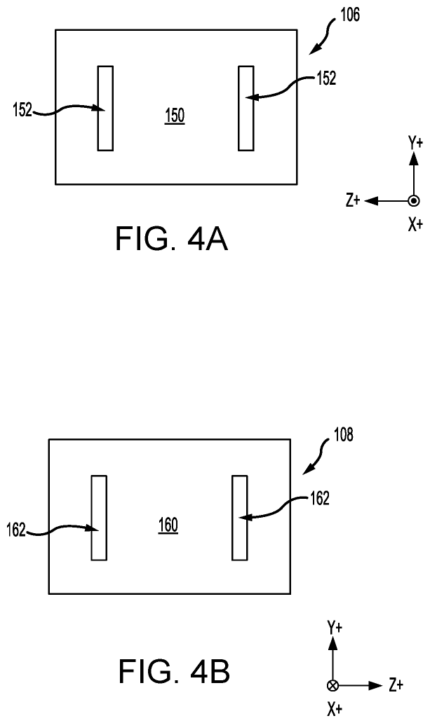

With reference to FIGS. 3A and 3B, a plan view and an aft-facing view of ejection seat 14 are illustrated, respectively. In accordance with various embodiments, ejection seat 14 includes a seat pan adjustment system 120. Seat pan adjustment system 120 includes one or more actuator(s), such as first actuator 122₁, second actuator 122₂, third actuator 122₃, and fourth actuator 122₄ (referred to collectively as actuators 122). Actuators 122 are configured to translate seat pan 104 relative to seat back 102, first side panel 106, and second side panel 108. In various embodiments, first actuator 122₁ is located proximate a left-front area of seat pan, second actuator 122₂ is located proximate a right-front area of seat pan 104, third actuator 122₃ is located proximate a left-back area of seat pan 104, and fourth actuator 122₄ is located proximate a right-back area of seat pan 104. While system 120 is shown having four actuators 122 with one actuator 122 located proximate each of the left-front, the right-front, the left-back, and the right-back areas of seat pan 104, it is contemplated and understood that system 120 may include any number of actuators 122 with one or more actuators 122 at any desired location.

Actuators 122 may comprise electromechanical actuators, hydraulic actuators, pneumatic actuators, linear actuators, rotary actuators, magnetic actuators, mechanical actuators, or any other suitable actuator, and/or combination of actuators. Actuators 122 are located between first side panel 106 and second side panel 108 and under seat pan 104. As used in the previous context “under” refers to an area opposite the surface on which an occupant of seat pan 104 sits. In this regard, and with particular reference to FIG. 3B, actuators 122 may contact and/or apply force to an underside surface 130 of seat pan 104. Underside surface 130 is opposite surface 132. An occupant of seat pan 104 sits on surface 132 of seat pan 104. Each actuator 122 is configured to adjust a height of its respective area of seat pan 104 relative to a floor 140, with momentary additional reference to FIG. 2. In various embodiments, floor 140 may be the floor of cockpit 18 (FIG. 1). Actuation of an actuator 122 changes a distance D between the portion of underside surface 130 contacting the actuator 122 and a plane 142 perpendicular to the direction of actuation (i.e. a plane parallel to the XZ plane of the provided XYZ axis). Distance D is measured in a direction parallel to the direction of translation of seat pan 104 (i.e., in a direction parallel to the Y axis of the provided XYZ axis).

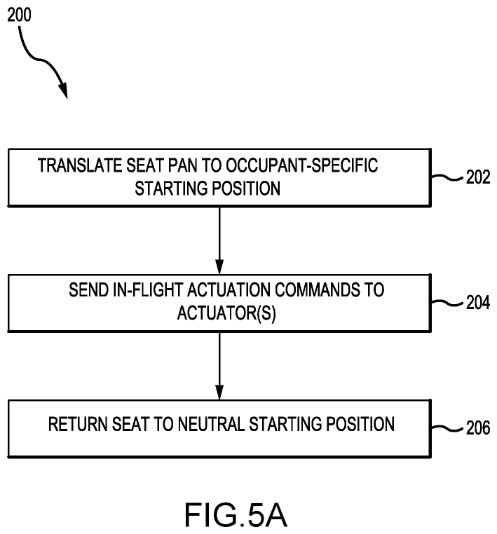

In accordance with various embodiments, one or more first (or left) alignment pin(s) 124 may be coupled to first side 107 of seat pan 104 and one or more second (or right) alignment pin(s) 126 may be coupled to second side 109 of seat pan 104. With additional reference to FIGS. 4A and 4B, an inboard surface 150 of first side panel 106 may define one or more first pin channel(s) 152. Inboard surface 150 is oriented toward first side 107 of seat pan 104. First pin channels 152 are configured to receive first alignment pins 124. Stated differently, each first alignment pin 124 may be located in a first pin channel 152. An inboard surface 160 of second side panel 108 may define one or more second pin channel(s) 162. Inboard surface 160 is oriented toward second side 109 of seat pan 104. Second pin channels 162 are configured to receive second alignment pins 126. Stated differently, each second alignment pin 126 may be located in a second pin channel 162. Locating first and second alignment pins 124, 126 in first and second pin channels 152, 162, respectively, may help guide translation of seat pan 104 in the vertical direction (i.e. in directions parallel to the Y-axis) during actuation of actuators 122.

Returning to FIGS. 3A and 3B, in accordance with various embodiments, system 120 includes a controller 170. Controller 170 is configured to control actuation of actuators 122. For example, controller 170 may send actuation commands 172 to each of first actuator 122₁, second actuator 122₂, third actuator 122₃, and fourth actuator 122₄. Actuation commands 172 cause the actuator 122 receiving the command to actuate. As described in further detail below, actuation commands 172 may include one or more initial actuation command(s) configured to adjust a height of seat pan 104 prior to takeoff and in-flight actuation commands sent during flight and configured to adjust a position of at least one of the left-front, the right-front, the left-back, or the right-back area of seat pan 104.

Controller 170 may include one or more of a general purpose processor, digital signal processor (DSP), application specific integrated circuit (ASIC), field programmable gate array (FPGA), or other programmable logic device, discrete gate, transistor logic, or discrete hardware components, or any various combinations thereof. A tangible, non-transitory computer-readable storage medium 174 may be in communication with controller 170. Storage medium 174 may comprise any tangible, non-transitory computer-readable storage medium known in the art. The storage medium 174 has instructions stored thereon that, in response to execution by controller 170, cause controller 170 to perform operations related to adjusting a position of seat pan 104. In this regard, controller 170 is configured to control actuation of actuators 122 and thereby control the position of each area of seat pan 104.

Controller 170 may send different actuation commands 172 to one or more of actuators 122 and/or may send actuation commands 172 to some and not others of actuators 122. For example, controller 170 may simultaneously (or nearly simultaneously) send a first actuation command 172 to first actuator 122₁ configured to increase distance D at left-front of seat pan 104 and a second actuation command 172 to second actuator 122₂ configured to decrease distance D at the right-front of seat pan 104. Or controller 170 may simultaneously (or nearly simultaneously) send a first actuation command 172 to first actuator 122₁ and second actuator 122₂ configured to increase distance D at the left-front and right-front areas of seat pan 104 and a second actuation command 172 to third actuator 122₃ and fourth actuator 122₄ configured to decrease distance D at the left-back and right-back areas of seat pan 104.

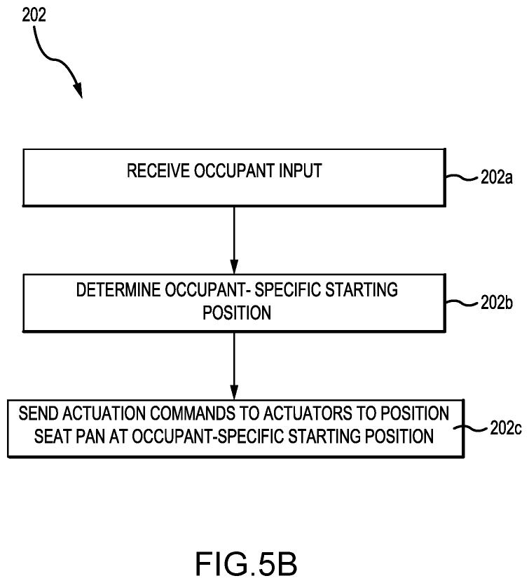

With additional reference to FIG. 5A, a method 200 for adjusting of seat pan 104 is illustrated. Method 200 may be carried out by controller 170 and system 120. In various embodiments, prior to occupant 16 entering aircraft 12, seat pan 104 may be at a neutral starting position. At the start of a flight, controller 190 may send actuation commands to translate seat pan 104 to an occupant-specific starting position (step 202).

With additional reference to FIG. 5B, step 202 may include controller 190 receiving occupant input 180 (step 202a), determining the occupant-specific starting position based on the occupant input 180 (step 202b), and sending initial actuation commands 172 to actuators 122 configured to position seat pan 104 at the occupant-specific starting position (step 202c).

Occupant input 180 may comprise physical characteristics of occupant 16 (e.g., occupant height, occupant weight, etc.) and/or ejection seat settings selected by occupant 16. In various embodiments, occupant input 180 may be physical characteristics that are measured in real-time via, for example, sensors on ejection seat 14. In various embodiments, occupant input 180 may comprise physical characteristics or preferred settings that have been previously entered, selected, and/or saved by occupant 16. In various embodiments, occupant input 180 may allow controller 170 to identify the occupant 16 and determine the seat pan position that corresponds to the identified occupant 16. Occupant input 180 may be received via occupant 16 manually entering the occupant input 180 or via a system that automatically determines the occupant input 180. For example, occupant input 180 may be input via a knob, switch, keyboard, touchpad, voice input, a radio frequency identification (RFID) or other scannable tag worn by occupant, facial recognition system, a smart card, eye scan system, or any system capable of allowing occupant input 180 to be sent to controller 170.

Returning to FIG. 5A, during flight, controller 170 will send in-flight actuation commands to one or more actuators 122 to make minor adjustments to the position of seat pan 104 (step 204). For example, the initial actuation commands for the occupant-specific starting position may be sent to all actuators 122 to adjust a height of the seat pan 104 relative to the floor 140. These initial actuation commands 172 may translate the seat pan 104 multiple inches at a time. For example, an initial actuation command 172 may cause seat pan 104 to translate 24.0 inches (61.0 cm) along seat back 102, 16.0 inches (40.6 cm) along seat back 102, 6.0 inches (15.2 cm) along seat back 102, 1.0 inch (2.5 cm) along seat back 102, or within any range of translation distances along seat back 102 that may be associated with locating the seat pan 104 at a proper and/or desired height for the current occupant 16 of seat pan 104.

The in-flight actuation commands 172 sent to actuators 122 may vary between actuators 122 and/or the in-flight actuation commands 172 may be sent to some of the actuators 122 and not to others of the actuators 122. Stated differently, controller 170 may send different in-flight actuation commands 172 to different actuators 122 and/or may send in-flight actuation commands 172 to some and not others of actuators 122. For example, controller 170 may simultaneously (or nearly simultaneously) send a first in-flight actuation command 172 to first actuator 122₁ and a second in-flight actuation command 172 to second actuator 122₂. The first in-flight actuation command 172 may be configured to increase distance D at left-front of seat pan 104. The second in-flight actuation command 172 may be configured to decrease distance D at the right-front of seat pan 104. Or controller 170 may simultaneously (or nearly simultaneously) send a first in-flight actuation command 172 to first actuator 122₁ and second actuator 122₂ and a second in-flight actuation command 172 to third actuator 122₃ and fourth actuator 122₄. The first in-flight actuation command 172 may be configured to increase distance D at the left-front and right-front areas of seat pan 104. The second in-flight actuation command 172 may be configured to decrease distance D at the left-back and right-back areas of seat pan 104. In various embodiments, the in-flight actuation commands 172 may make smaller adjustments to the position of seat pan 104, as compared to the initial actuation command. For example, an in-flight actuation command 172 may cause an actuator 122 to translate seat pan 104 2.0 inches (5.1 cm), or 1.0 inch (2.5 cm), or 0.75 inches (1.9 cm), or 0.5 inches (1.3 cm), or 0.25 inches (0.6 cm), or within any desired range of distances.

In accordance with various embodiments, controller 170 may send the in-flight actuation commands 172 at a pre-determined time interval or in accordance with a programmed sequence. For example, at 30 minutes after takeoff, controller 170 may send one or more first in-flight actuation command(s) 172 configured to change the position (e.g., increase or decrease the height) of the first side 107 of seat pan 104. Five minutes after sending the first in-flight actuation commands, controller 170 may send one or more second in-flight actuation command(s) configured to change the position of the first side 107 and second side 109 of seat pan 104. For example, the second in-flight actuation commands may decrease the height of first side 107 and increase the height of the second side 109. In various embodiments, controller 170 may send an in-flight actuation command 172 configured to adjust the position of one area (e.g., the right-front or the left-back) of seat pan 104. The above times and seat pan adjustment directions are described for exemplary purposes, it is contemplated and understood that any time interval and any desired adjustments may be made by controller 170.

In accordance with various embodiments, controller 170 may be configured to actuate seat pan 104 through a pre-set series of positions at pre-determined time intervals (e.g., a first position at a first time (30 min), a second position at a second time (60 min), a third position at third time (90 min), etc.). For example, controller 170 may send a first in-flight actuation command 172 to at least one of actuators 122 at a first pre-set time after takeoff. Controller 170 may then send a second in-flight actuation command 172 to another actuator 122 at a second pre-set time after takeoff.

Controller 170 may also be configured to recognize one or more override commands from occupant 16. In various embodiments, in response to receiving a next position signal from occupant 16, controller 170, sends in-flight actuation commands 172 configured to cause actuators 122 to actuate to the next position in the pre-set series of positions. Occupant 16 may send the next position signal via manual input (e.g., turning a knob, pressing a button, using touchscreen, etc.), voice command, or any other suitable means. When a flight is completed and/or upon occupant 16 exiting seat pan 104, controller 170 will send post-flight actuation commands 172 configured to return seat pan 104 to the neutral starting position (step 206).

The in-flight position adjustments made to seat pan 104 via actuators 122 may increase seat occupant comfort and/or reduce occurrences of the occupant's legs “falling asleep.” Adjustments to the position of the various areas of seat pan 104 can reduce prolonged periods of pressure on certain areas of the body (e.g., the coccyx) and/or may help with blood flow to the legs. In this regard, seat pan adjustment system 120 and method 200 may allow for longer flight times.

In various embodiments, controller 170 is configured to recognize a stop adjustments signal from occupant 16. In response to receiving the stop adjustments signal, controller 170 may leave seat pan 104 in its current position (i.e., controller 170 will stop automatically sending in-flight actuation commands 172 to actuators 122 at the pre-set time intervals). Occupant 16 may send the stop adjustment signal via manual input (e.g., turning a knob, pressing a button, touchscreen, etc.), voice command, or any other suitable means.

In various embodiments, controller 170 is configured to recognize a return to start position signal from occupant 16. In response to receiving the return to start position signal, controller 170 sends in-flight actuation commands 172 configured to return seat pan 104 to the occupant-specific starting position. In response to receiving the return to start position signal and after seat pan 104 is returned to the occupant-specific starting position, controller 170 may cease from sending in-flight actuation commands 172, such that seat pan 104 remains in the occupant-specific starting position for the remainder of the flight. Occupant 16 may send the return to start position signal via manual input (e.g., turning a knob, pressing a button, touchscreen, etc.), voice command, or any other suitable means.

In various embodiments, controller 170 is configured to recognize an initiation of an ejection sequence signal (also referred to as an ejection signal). The ejection signal may be sent to controller 170 in response to actuation of ejection handle 110. Controller 170 is configured to lock seat pan 104 in its current position, in response to receiving the ejection signal. For example, in response to receiving the ejection signal, controller 170 will not send a new in-flight actuation command 172. In various embodiments, controller 170 will send a lock signal to actuators 122, in response to receiving the ejection signal. The lock signal may prevent further actuation of actuators 122. If an adjustment is in process when the ejection signal is received, controller 170 may be configured to allow the adjustment to be completed and then send the lock signal. In various embodiments, controller 170 may be configured to send the lock signal immediately upon receiving the ejection signal such that actuators 122 are prevented from completing an adjustment that was in process when the ejection signal was received.

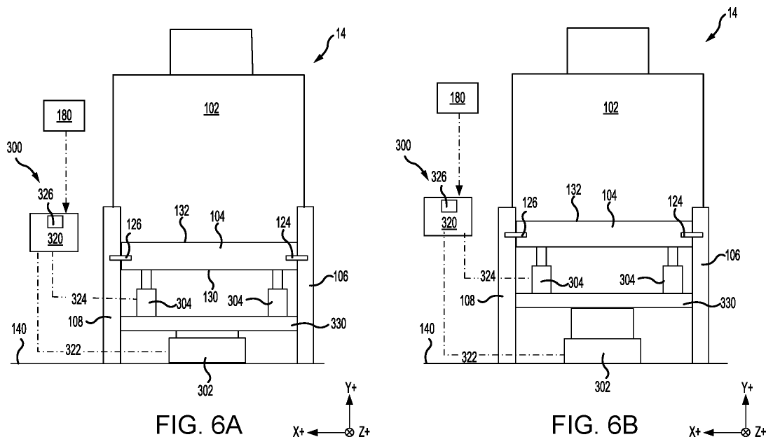

With reference to FIGS. 6A and 6B, ejection seat 14 including a seat pan adjustment system 300 is illustrated. Ejection seat 14 may include seat pan adjustment system 300 in place of seat pan adjustment system 120 in FIGS. 3A and 3B. Seat pan adjustment system 300 includes a primary actuator 302 and secondary actuators 304. Secondary actuators 304 are similar to actuators 122 in FIGS. 3A and 3B. Seat pan adjustment system 300 further includes a controller 320. Controller 320 is configured to control actuation of primary actuator 302 and secondary actuators 304. For example, controller 320 may send actuation commands 322 to primary actuator 302, and actuation commands 324 to secondary actuators 304. Controller 320 may include one or more of a general purpose processor, DSP, ASIC, field FPGA, or other programmable logic device, discrete gate, transistor logic, or discrete hardware components, or any various combinations thereof. A tangible, non-transitory computer-readable storage medium 326 may be in communication with controller 320. Storage medium 326 may comprise any tangible, non-transitory computer-readable storage medium known in the art. The storage medium 326 has instructions stored thereon that, in response to execution by controller 320, cause controller 320 to perform operations related to adjusting a position of seat pan 104. In this regard, controller 320 is configured to control actuation of primary actuator 302 and secondary actuators 304.

In various embodiments, primary actuator 302 may control the initial height adjustments of seat pan 104. In various embodiments, controller 320 may send initial actuation commands, as described with reference to method 200, to primary actuator 302 to position seat pan 104 at the occupant-specific starting position. For example, actuation commands 322 and primary actuator 302 may translate seat pan 104 multiple inches at a time. For example, actuation commands 322 and primary actuator 302 may cause seat pan 104 to translate 24.0 inches (61.0 cm), or 16.0 inches (40.6 cm), or 6.0 inches (15.2 cm), or 1.0 inches (2.5 cm) or within any desired range of translation distances along seat back 102. In various embodiments, secondary actuators 304 translate with seat pan 104 in response to actuation of primary actuator 302. For example, in various embodiments, secondary actuators 304 may be located on a plate 330. Actuation of primary actuator 302 causes plate 330 and secondary actuators 304 to translate relative to seat back 102, first side panel 106, and second side panel 108. Stated differently, actuation of primary actuator 302 may change the distance between the floor 140 and plate 330 and between the floor 140 and secondary actuators 304.

In accordance with various embodiments, actuation commands 324 and secondary actuators 304 may make smaller adjustments, as compared to the actuation commands 322 and primary actuator 302. For example, actuation commands 324 may cause a secondary actuator 304 to translate seat pan 104 2.0 inches (5.1 cm), or 1.0 inches (2.5 cm), or 0.75 inches (1.9 cm), or 0.5 inches (1.3 cm), or 0.25 inches (0.6 cm), or within any desired range of translation distances. Secondary actuators 304 being configured to make small adjustments (e.g., 1.0 inches or less) may allow for relatively light weight actuators to be employed as secondary actuators 304. Controller 320 may send in-flight actuation commands 172, as described with reference to method 200, to secondary actuators 304. Secondary actuators 304 being configured to make small adjustments (e.g., 1.0 inches or less) may allow for relatively light weight actuators to be employed as secondary actuators 304.

In accordance with various embodiments, primary actuator 302 is located under seat pan 104 and between first side panel 106 and second side panel 108. Primary actuator 302 may be located forward of seat back 102. Stated differently, primary actuator 302 may be located outside (or not within) seat back 102. In various embodiments, during expulsion of ejection seat 14, primary actuator 302 may remain in the aircraft 12 and secondary actuators 304 may translate with ejection seat 14. Stated differently, primary actuator 302 may remain stationary during expulsion of ejection seat 14 from aircraft 12. Primary actuator 302 remaining in aircraft 12 reduces the ejection weight of ejection seat 14. The in-flight position adjustments made to seat pan 104 via secondary actuators 304 may increase seat occupant comfort and/or reduce occurrences of the occupant's legs “falling asleep.” Adjustments to the position of the various areas of seat pan 104 can reduce prolonged periods of pressure on certain areas of the body (e.g., the coccyx) and/or may help with blood flow to the legs. In this regard, seat pan adjustment system 300 may allow for longer flight times.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosures. The scope of the disclosures is accordingly to be limited by nothing other than the appended claims and their legal equivalents, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods, and apparatus are provided herein. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is intended to invoke 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. An ejection seat, comprising:
a seat back;
a seat pan configured to translate along the seat back; and
a seat pan adjustment system configured to adjust a positioning of the seat pan, the seat pan adjustment system comprising:
a first actuator configured to adjust a position of a first area of the seat pan;
a second actuator configured to adjust a position of a second area of the seat pan; and
a controller configured to send in-flight actuation commands to the first actuator and the second actuator.

2. The ejection seat of claim 1, further comprising:
a first side panel located along a first side of the seat pan;
a second side panel located along a second side of the seat pan opposite the first side of the seat pan;
a first guide pin coupled to the first side of the seat pan and located in a first pin channel defined by an inboard surface of the first side panel; and
a second guide pin coupled to the second side of the seat pan and located in a second pin channel defined by an inboard surface of the second side panel.

3. The ejection seat of claim 2, wherein the first actuator is located proximate the first side of the seat pan, and wherein the second actuator is located proximate the second side of the seat pan.

4. The ejection seat of claim 3, wherein the seat pan adjustment system further comprises a primary actuator operably coupled to the seat pan, wherein actuation of the primary actuator causes the seat pan, the first actuator, and the second actuator to translate relative to the seat back.

5. The ejection seat of claim 4, wherein the primary actuator is located under the seat pan.

6. The ejection seat of claim 5, wherein the primary actuator is configured to remain stationary and the first actuator and the second actuator translate with the seat pan during expulsion of the ejection seat.

7. The ejection seat of claim 4, wherein the controller is configured to send an initial actuation command to at least the primary actuator to position the seat pan at an occupant-specific starting position, and wherein the controller sends the in-flight actuation commands to at least one of the first actuator or the second actuator at a pre-selected time interval after sending the initial actuation command to the primary actuator.

8. The ejection seat of claim 1, wherein the seat pan adjustment system further comprises:
a third actuator configured to adjust a position of a third area of the seat pan; and
a fourth actuator configured to adjust a position of a fourth area of the seat pan, wherein the first actuator is located proximate a left-front of the seat pan, the second actuator is located proximate a right-front of the seat pan, the third actuator is located proximate a left-back of the seat pan, and the fourth actuator is located proximate a right-back of the seat pan.

9. A seat pan adjustment system for an ejection seat, comprising:
a first actuator configured to adjust a position of a first area of a seat pan;
a second actuator configured to adjust a position of a second area of the seat pan;
a controller in communication with the first actuator and the second actuator; and
a tangible, non-transitory computer-readable storage medium having instructions stored thereon for adjusting the seat pan that, in response to execution by the controller, cause the controller to perform operations comprising:
sending, by the controller, an initial actuation command configured to position the seat pan at an occupant-specific starting position; and
sending, by the controller, a series of in-flight actuation commands to the first actuator and the second actuator.

10. The seat pan adjustment system of claim 9, wherein the operations further comprise:
receiving, by the controller, an occupant input; and
determining, by the controller, the occupant-specific starting position based on the occupant input.

11. The seat pan adjustment system of claim 10, wherein sending, by the controller, the series of in-flight actuation commands to the first actuator and the second actuator comprises:
sending, by the controller, a first in-flight actuation command to the first actuator at a first pre-set time after takeoff, wherein the first in-flight actuation command is configured to adjust the position of the first area of the seat pan; and
sending, by the controller, a second in-flight actuation command to the second actuator at a second pre-set time after takeoff, wherein the second in-flight actuation command is configured to adjust the position of the second area of the seat pan.

12. The seat pan adjustment system of claim 11, wherein the operations further comprise:
receiving, by the controller, a next position signal; and
sending, by the controller, a next in-flight actuation command in the series of in-flight actuation commands in response to receiving the next position signal.

13. The seat pan adjustment system of claim 11, wherein the operations further comprise:
receiving, by the controller, a return to start position signal; and
sending, by the controller, an in-flight actuation command configured to position the seat pan at the occupant-specific starting position.

14. The seat pan adjustment system of claim 11, wherein the operations further comprise receiving, by the controller, a stop adjustments signal, wherein the controller is configured to cease from sending any remaining in-flight actuation commands in the series of in-flight actuation commands in response to receiving the stop adjustment signal.

15. The seat pan adjustment system of claim 9, comprising a primary actuator configured to adjust a height of the seat pan, wherein the controller is configured to send the initial actuation command to at least the primary actuator, and wherein actuation of the primary actuator causes the seat pan, the first actuator, and the second actuator to translate relative to a seat back of the ejection seat.

16. A method for adjusting a seat pan of an ejection seat, comprising:
receiving, by a controller, an occupant input;
determining, by the controller, an occupant-specific starting position based on the occupant input;
sending, by the controller, an initial actuation command configured to translate the seat pan from a neutral starting position to the occupant-specific starting position; and
sending, by the controller, a series of in-flight actuation commands to a first actuator and a second actuator, the first actuator being configured to adjust a position of a first area of the seat pan, and the second actuator being configured to adjust a position of a second area of the seat pan.

17. The method of claim 16, wherein sending, by the controller, the series of in-flight actuation commands to the first actuator and the second actuator comprises:
sending, by the controller, a first in-flight actuation command to the first actuator at a first pre-set time after takeoff; and
sending, by the controller, a second in-flight actuation command to the second actuator at a second pre-set time after takeoff.

18. The method of claim 16, further comprising:
receiving, by the controller, a return to start position signal; and
sending, by the controller, an in-flight actuation command configured to position the seat pan at the occupant-specific starting position.

19. The method of claim 16, wherein the controller sends the initial actuation command to at least a primary actuator, and wherein actuation of the primary actuator causes the seat pan, the first actuator, and the second actuator to translate relative to a seat back of the ejection seat.

20. The method of claim 19, further comprising sending, by the controller, a final actuation command configured to position the seat pan at the neutral starting position.
